(19) United States
(12) Patent Application Publication
(10) Pub. No.: US 2026/0129145 A1
(43) Pub. Date: May 7, 2026

(54) THREE-DIMENSIONAL DISPLAY METHOD FOR VIDEO CONFERENCE AND VIDEO CONFERENCE SYSTEM

(71) Applicant: Acer Incorporated, New Taipei City (TW)

(72) Inventors: Chi-Kang LEE, New Taipei City (TW); Shih-Hao LIN, New Taipei City (TW); Sergio CANTERO CLARES, New Taipei City (TW); Pei-Yang TSAI, New Taipei City (TW)

(73) Assignee: Acer Incorporated, New Taipei City (TW)

(21) Appl. No.: 19/292,407

(22) Filed: Aug. 6, 2025

(30) Foreign Application Priority Data
Nov. 1, 2024 (TW) 113141841

(51) Int. Cl. H04N 7/15; G06T 1/00; H04N 13/20; H04N 13/302

(52) U.S. Cl. CPC H04N 7/15; G06T 1/0021; H04N 13/20; H04N 13/302

(57) ABSTRACT

A three-dimensional display method for video conference and the video conference system are provided. The three-dimensional display method includes the following steps. A first electronic device generates an image. The first electronic device encodes a hidden watermark in the image. The first electronic device transmits the image to a second electronic device. The second electronic device displays the image in a window of a display frame. The second electronic device searches for a rectangular box on the display frame. The second electronic device determines whether the hidden watermark is decoded in the rectangular box. If the hidden watermark is decoded in the rectangular box, the second electronic device performs a stereoscopic imaging process for the content of the rectangular box.

This application claims the benefit of Taiwan application Serial No. 113141841, filed November 1, 2024, the disclosure of which is incorporated by reference herein in its entirety.

### TECHNICAL FIELD

The disclosure relates in general to a display method and a conference system, and more particularly to a three-dimensional display method for a video conference and a video conference system.

### BACKGROUND

In recent years, the application of 3D images has become more and more widespread, from the early 3D glasses to the current naked-eye 3D displays. Especially when conducting a video conference, it may be necessary to display a 3D object. At this time, if the object can be presented in a 3D way, it can give the other party an immersive visual experience, making the meeting process closer to the actual situation and making the meeting more smooth.

### SUMMARY

The present disclosure relates to a three-dimensional display method for a video conference and a video conference system, which encodes a hidden watermark into an image, so that when the image is transmitted to other electronic devices, a three-dimensional image could be obtained based on the decoded hidden watermark.

According to one embodiment, a three-dimensional display method for a video conference. The three-dimensional display method for the video conference includes the following steps. A first electronic device generates an image. The first electronic device encodes a hidden watermark in the image. The first electronic device transmits the image to a second electronic device. The second electronic device displays the image in a window of a display frame. The second electronic device searches for a rectangular box on the display frame. The second electronic device determines whether the hidden watermark is decoded in the rectangular box. If the hidden watermark is decoded in the rectangular box, the second electronic device performs a stereoscopic imaging process for the content of the rectangular box.

According to another embodiment, a three-dimensional display method for a video conference is provided. The three-dimensional display method for the video conference includes the following steps. A first electronic device generates an image. The first electronic device searches for an object in the image. The first electronic device encodes a hidden watermark in the object of the image. The first electronic device transmits the image to a second electronic device. The second electronic device displays the image on a display frame. The second electronic device searches for an object region in the display frame. The second electronic device determines whether the hidden watermark is decoded in the object region. The second electronic device performs a stereoscopic imaging process for a content of the object region, if the hidden watermark is decoded in the object region.

According to an alternative embodiment, a video conference system is provided. The video conference system includes a first electronic device and a second electronic device. The first electronic device includes an image generation unit, a watermark encoding unit and a first transmission unit. The image generation unit is used for generating an image. The watermark encoding unit is used for encoding a hidden watermark in the image. The first transmission unit is used for transmitting the image. The second electronic device includes a second transmission unit, a display unit, a square searching unit, a watermark decoding unit and a stereo imaging unit. The second transmission unit is used for receiving the image. The display unit is used for displaying the image in a window of a display frame. The square searching unit is used for searching for a rectangular box on the display frame. The watermark decoding unit is used for determining whether the hidden watermark is decoded in the rectangular box. If the hidden watermark is decoded in the rectangular box, the stereo imaging unit performs a stereoscopic imaging process for a content of the rectangular box.

### BRIEF DESCRIPTION OF THE DRAWINGS

FIG. 1 illustrates a three-dimensional display method for a video conference according to an embodiment of the present disclosure.

FIG. 2 illustrates a block diagram of a video conference system according to an embodiment of the present disclosure.

FIG. 3 is a flowchart illustrating a three-dimensional display method for the video conference according to an embodiment of the present disclosure.

FIG. 4 illustrates a three-dimensional display method for the video conference according to another embodiment of the present disclosure.

FIG. 5 illustrates a block diagram of a video conference system according to another embodiment of the present disclosure.

FIG. 6 is a flowchart illustrating a three-dimensional display method for the video conference according to another embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

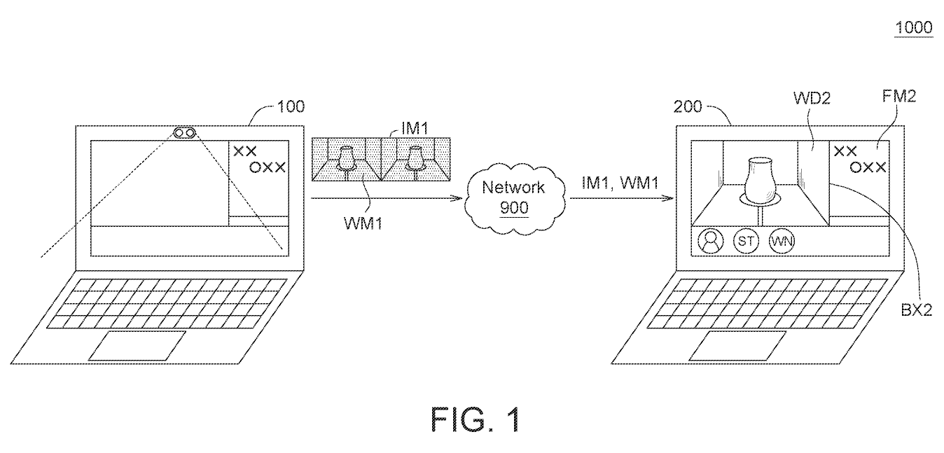

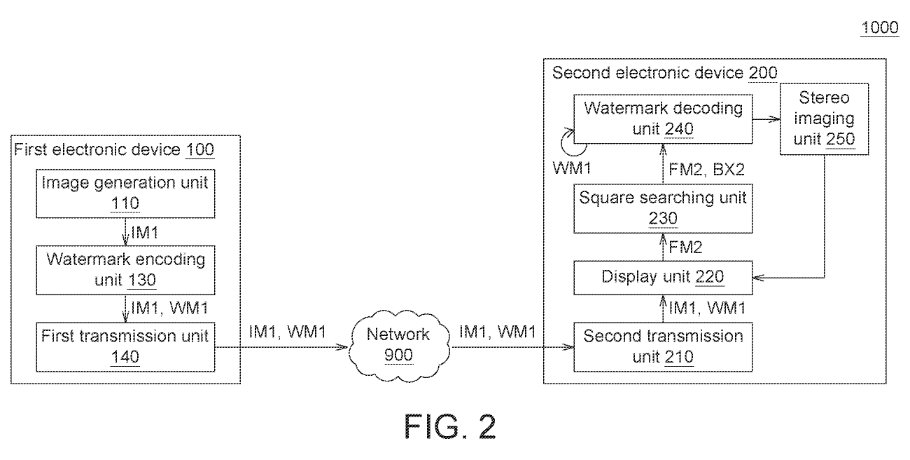

Please refer to FIG. 1 and FIG. 2. FIG. 1 illustrates a three-dimensional display method for a video conference according to an embodiment of the present disclosure. FIG. 2 illustrates a block diagram of a video conference system 1000 according to an embodiment of the present disclosure. As shown in FIG. 2, the video conference system 1000 includes a first electronic device 100 and a second electronic device 200. The first electronic device 100 includes an image generation unit 110, a watermark encoding unit 130, and a first transmission unit 140. The image generation unit 110 is used to perform an image generation process. The watermark encoding unit 130 is used to perform an encoding process. The first transmission unit 140 is used to perform a transmission process.

As shown in FIG. 2, the second electronic device 200 includes a second transmission unit 210, a display unit 220, a square searching unit 230, a watermark decoding unit 240 and a stereo imaging unit 250. The second transmission unit 210 is used to perform a transmission process. The display unit 220 is used to display various information, such as a naked-eye stereo display. The square searching unit 230 is used to perform a search process. The watermark decoding unit 240 is used to perform a decoding process. The stereo imaging unit 250 is used to perform a stereoscopic imaging process.

The image generation unit 110, the watermark encoding unit 130, the square searching unit 230, the watermark decoding unit 240 and/or the stereo imaging unit 250 is, for example, a circuit, a circuit board, a storage device storing program codes or a chip. The chip is, for example, a central processing unit (CPU), a programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), an embedded system, a field programmable gate array (FPGA), other similar element or a combination thereof.

The first transmission unit 140 and/or the second transmission unit 210 is, for example, a wireless transmission module or a wired transmission module.

In the video conference system 1000, the first electronic device 100 could be used to encode the hidden watermark WM1 in the entire range of the image IM1, and the second electronic device 200 could decode the hidden watermark WM1 from the image IM1 to quickly obtain a three-dimensional image. The following flowchart describes in detail the operation of each component.

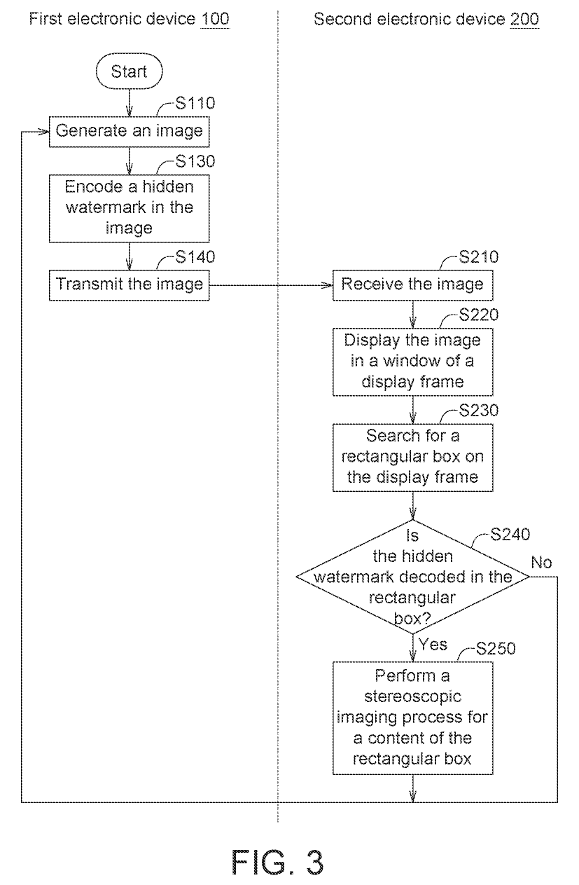

Please refer to FIG. 2 and FIG. 3. FIG. 3 is a flowchart illustrating a three-dimensional display method for the video conference according to an embodiment of the present disclosure. The three-dimensional display method for the video conference includes steps S110, S130, S140, and S210 to S250. In the step S110, as shown in FIG. 1 and FIG. 2, the image generation unit 110 of the first electronic device 100 generates an image IM1. After the dual lenses of the first electronic device 100 capture a left eye image and a right eye image, the left eye image and the right eye image are arranged side by side to form the image IM1. The image IM1 is a side-by-side image.

Next, in the step S130, as shown in FIG. 1 and FIG. 2, the watermark encoding unit 130 of the first electronic device 100 encodes the hidden watermark WM1 in the image IM1. The watermark encoding unit 130 encodes the hidden watermark WM1 in the entire range of the image IM1. The hidden watermark WM1 is dispersed in several pixels in the image IM1, and the human eye cannot perceive the hidden watermark WM1.

Then, in the step S140, as shown in FIG. 1 and FIG. 2, the first transmission unit 140 of the first electronic device 100 transmits the image IM1 having the hidden watermark WM1.

Next, in the step S210, as shown in FIG. 1 and FIG. 2, the second transmission unit 210 of the second electronic device 200 receives the image IM1 having the hidden watermark WM1.

Then, in the step S220, as shown in FIG. 1 and FIG. 2, the display unit 220 of the second electronic device 200 displays the image IM1 in a window WD2 of a display frame FM2. In the video conference, the display frame FM2 is divided into a plurality of windows. Only the window WD2 is used to display the image IM1.

Next, in the step S230, as shown in FIG. 1 and FIG. 2, the square searching unit 230 searches for the rectangular box BX2 in the display frame FM2 of the display unit 220. When the display frame FM2 is divided into a plurality of windows, the square searching unit 230 will search out a plurality of rectangular boxes BX2.

In the step S240, as shown in FIG. 2, the watermark decoding unit 240 determines whether the hidden watermark WM1 can be decoded from the rectangular box BX2. If the watermark decoding unit 240 can decode the hidden watermark WM1 from the rectangular box BX2, the process proceeds to the step S250; if the watermark decoding unit 240 cannot decode the hidden watermark WM1 from the rectangular box BX2, the process returns to the step S110. The display frame FM2 of the display unit 220 may include multiple rectangular boxes BX2 at the same time, and the square searching unit 230 and the watermark decoding unit 240 search for one of the rectangular boxes BX2 of the image IM1 having the hidden watermark WM1.

Then, in the step S250, as shown in FIG. 1 and FIG. 2, the stereo imaging unit 250 performs the stereoscopic imaging process for the content of the rectangular box BX2 having the hidden watermark WM1. In this step, the stereo imaging unit 250 of the second electronic device 200 performs the stereoscopic imaging process only for the content of the rectangular box BX2, and the stereo imaging unit 250 of the second electronic device 200 does not perform the stereoscopic imaging process for the content outside the rectangular box BX2.

According to the above three-dimensional display method for the video conference, the first electronic device 100 could be used to encode the hidden watermark WM1 in the entire range of the image IM1, and the second electronic device 200 could decode the hidden watermark WM1 from the image IM1 to quickly obtain the three-dimensional image.

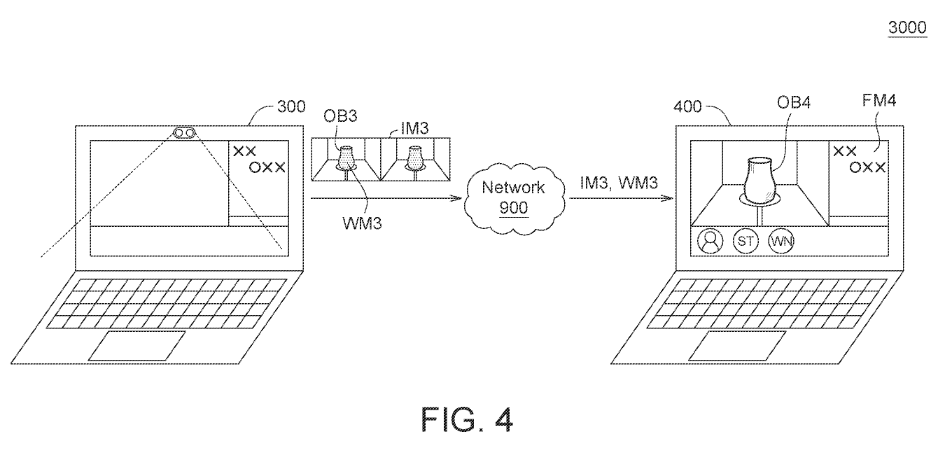

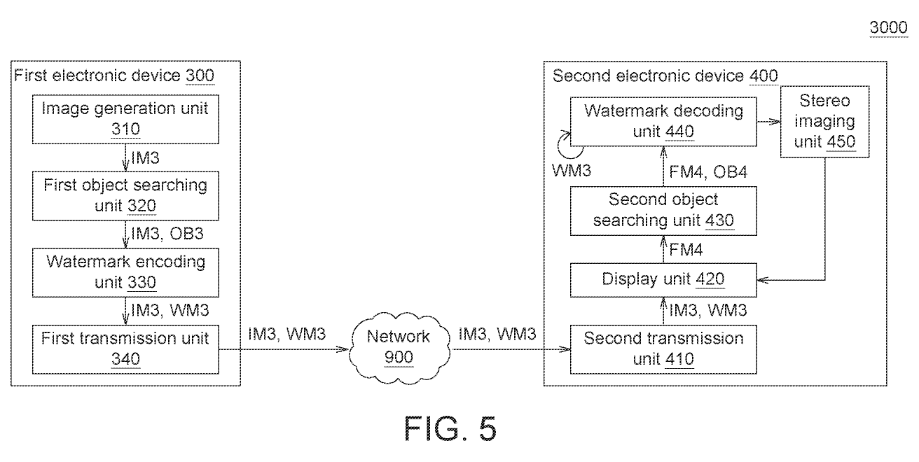

Please refer to FIG. 4 and FIG. 5. FIG. 4 illustrates a three-dimensional display method for the video conference according to another embodiment of the present disclosure. FIG. 5 illustrates a block diagram of a video conference system 3000 according to another embodiment of the present disclosure. The video conference system 3000 includes a first electronic device 300 and a second electronic device 400. As shown in FIG. 5, the first electronic device 300 includes an image generation unit 310, a first object searching unit 320, a watermark encoding unit 330 and a first transmission unit 340. The image generation unit 310 is used to perform an image generation process. The first object searching unit 320 is used to search for an object. The watermark encoding unit 330 is used to perform an encoding process. The first transmission unit 340 is used to perform a transmission process.

The second electronic device 400 includes a second transmission unit 410, a display unit 420, a second object search unit 430, a watermark decoding unit 440 and a stereo imaging unit 450. The second transmission unit 410 is used to perform a transmission process. The display unit 420 is used to display various information, such as a naked-eye stereo display. The second object search unit 430 is used to search for objects. The watermark decoding unit 440 is used to perform a decoding process. The stereo imaging unit 450 is used to perform a stereoscopic imaging process.

The image generation unit 310, the first object searching unit 320, the watermark encoding unit 330, the second object searching unit 430, the watermark decoding unit 440 and/or the stereo imaging unit 450 is, for example, a circuit, a circuit board, a storage device storing program codes or a chip. The chip is, for example, a central processing unit (CPU), a programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), an embedded system, a field programmable gate array (FPGA), other similar element or a combination thereof.

The first transmission unit 340 and/or the second transmission unit 410 is, for example, a wireless transmission module or a wired transmission module.

In the video conference system 3000, the first electronic device 300 can encode the hidden watermark WM3 into a specific object in the image IM3, and the second electronic device 400 can decode the hidden watermark WM3 from the image IM3 to quickly obtain a three-dimensional image. The following flowchart describes in detail the operation of each component.

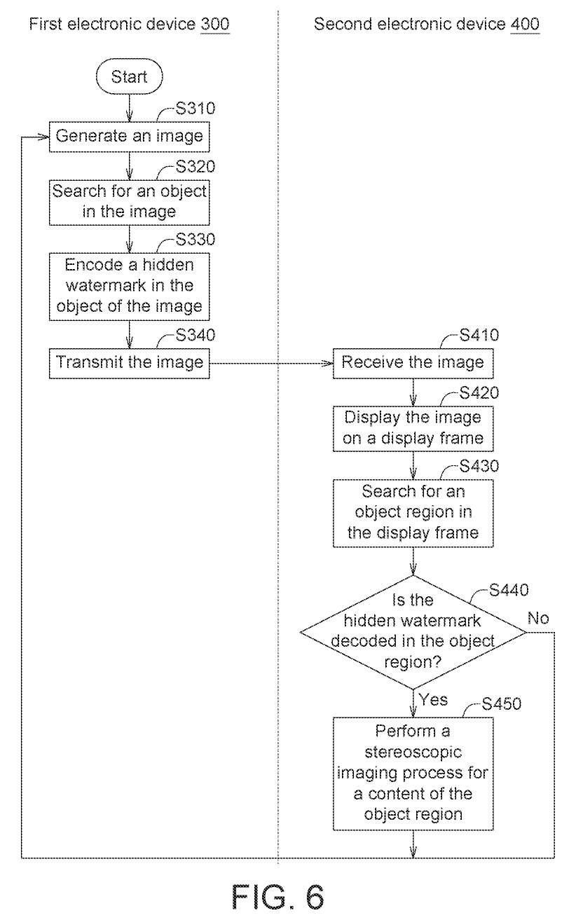

Please refer to FIG. 5 and FIG. 6. FIG. 6 is a flowchart illustrating a three-dimensional display method for the video conference according to another embodiment of the present disclosure. The three-dimensional display method for the video conference includes steps S310 to S340, S410 to S450. In the step S310, as shown in FIG. 4 and FIG. 5, the image generation unit 310 of the first electronic device 300 generates an image IM3. After the dual lenses of the first electronic device 300 capture a left eye image and a right eye image, the left eye image and the right eye image are arranged side by side to form the image IM3. The image IM3 is a side-by-side image.

Next, in the step S320, as shown in FIG. 4 and FIG. 5, the first object searching unit 320 of the first electronic device 300 searches for an object OB3 in the image IM3.

Afterwards, in the step S330, as shown in FIGS. 4 and 5, the watermark encoding unit 330 of the first electronic device 300 encodes a hidden watermark WM3 into the object OB3 of the image IM3. That is, the hidden watermark WM3 is only encoded in the object OB3, not in the entire image IM3. The hidden watermark WM3 is scattered in a plurality of pixels in the object OB3, and the human eye cannot perceive the hidden watermark WM3.

Then, in the step S340, as shown in FIG. 4 and FIG. 5, the first transmission unit 340 of the first electronic device 300 transmits the image IM3 having the hidden watermark WM3.

Next, in the step S410, as shown in FIGS. 4 and 5, the second transmission unit 410 of the second electronic device 400 receives the image IM3 having the hidden watermark WM3.

Then, in the step S420, as shown in FIGS. 4 and 5, the display unit 420 of the second electronic device 400 displays the image IM3 on a display frame FM4.

Next, in the step S430, as shown in FIGS. 4 and 5, the second object searching unit 430 searches for an object region OB4 in the display frame FM4 of the display unit 420. The display frame FM4 may display several different objects, and the second object searching unit 430 will search for several object regions OB4.

In the step S440, as shown in FIGS. 4 and 5, the watermark decoding unit 440 determines whether the hidden watermark WM3 can be decoded in the object region OB4. If the watermark decoding unit 440 can decode the hidden watermark WM3 in the object region OB4, the process proceeds to the step S450; if the watermark decoding unit 440 cannot decode the hidden watermark WM3 in the object region OB4, the process returns to the step S310. The display frame FM4 of the display unit 420 may include multiple objects at the same time, and the second object searching unit 430 and the watermark decoding unit 440 search for the object region OB4 having the hidden watermark WM3.

Then, in the step S450, as shown in FIGS. 4 and 5, the stereo imaging unit 450 performs stereoscopic imaging process for the content of the object region OB4. In this step, the stereo imaging unit 450 of the second electronic device 400 performs the stereoscopic imaging process only for the content of the object region OB4, and the stereo imaging unit 450 of the second electronic device 400 does not perform the stereoscopic imaging process for the content outside the object region OB4.

According to the above three-dimensional display method for the video conference, the first electronic device 300 could encode the hidden watermark WM3 into the specific object of the image IM3, and the second electronic device 400 could decode the hidden watermark WM3 from the image IM3 to quickly obtain a three-dimensional image.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A three-dimensional display method for a video conference, comprising:
generating an image by a first electronic device;
encoding a hidden watermark in the image by the first electronic device;
transmitting the image to a second electronic device by the first electronic device;
displaying the image in a window of a display frame by the second electronic device;
searching for a rectangular box on the display frame by the second electronic device;
determining whether the hidden watermark is decoded in the rectangular box by the second electronic device; and
performing a stereoscopic imaging process for a content of the rectangular box by the second electronic device, if the hidden watermark is decoded in the rectangular box.

2. The three-dimensional display method for the video conference according to claim 1, wherein the first electronic device encodes the hidden watermark in an entire area of the image.

3. The three-dimensional display method for the video conference according to claim 1, wherein the image is a side-by-side image.

4. The three-dimensional display method for the video conference according to claim 1, wherein the second electronic device displays the image with a naked-eye stereo display.

5. The three-dimensional display method for the video conference according to claim 1, wherein the second electronic device only performs the stereoscopic imaging process for the content of the rectangular box, and does not perform the stereoscopic imaging process for a content outside the rectangular box.

6. The three-dimensional display method for the video conference according to claim 1, wherein the hidden watermark is spread over a plurality of pixels.

7. The three-dimensional display method for the video conference according to claim 1, wherein the hidden watermark is spread over a plurality of pixels in an entire area of the image.

8. A three-dimensional display method for a video conference, comprising:
generating an image by a first electronic device;
searching for an object in the image by the first electronic device;
encoding a hidden watermark in the object of the image by the first electronic device;
transmitting the image to a second electronic device by the first electronic device;
displaying the image on a display frame by the second electronic device;
searching for an object region in the display frame by the second electronic device;
determining whether the hidden watermark is decoded in the object region by the second electronic device; and
performing a stereoscopic imaging process for a content of the object region by the second electronic device, if the hidden watermark is decoded in the object region.

9. The three-dimensional display method for the video conference according to claim 8, wherein the first electronic device encodes the hidden watermark in a partial area of the image.

10. The three-dimensional display method for the video conference according to claim 8, wherein the image is a side-by-side image.

11. The three-dimensional display method for the video conference according to claim 8, wherein the second electronic device displays the image with a naked-eye stereo display.

12. The three-dimensional display method for the video conference according to claim 8, wherein the second electronic device only performs the stereoscopic imaging process for the content of the object region, and does not perform the stereoscopic imaging process for a content outside the object region.

13. The three-dimensional display method for the video conference according to claim 8, wherein the object region is an irregular shape.

14. The three-dimensional display method for the video conference according to claim 8, wherein the hidden watermark is spread over a plurality of pixels.

15. A video conference system, comprising:
a first electronic device, including:
an image generation unit, used for generating an image;
a watermark encoding unit, used for encoding a hidden watermark in the image; and
a first transmission unit, used for transmitting the image; and
a second electronic device, including:
a second transmission unit, used for receiving the image;
a display unit, used for displaying the image in a window of a display frame;
a square searching unit, used for searching for a rectangular box on the display frame;
a watermark decoding unit, used for determining whether the hidden watermark is decoded in the rectangular box; and
a stereo imaging unit, wherein if the hidden watermark is decoded in the rectangular box, the stereo imaging unit performs a stereoscopic imaging process for a content of the rectangular box.

16. The video conference system according to claim 15, wherein the first electronic device encodes the hidden watermark in an entire area of the image.

17. The video conference system according to claim 15, wherein the image is a side-by-side image.

18. The video conference system according to claim 15, wherein the second electronic device displays the image with a naked-eye stereo display.

19. The video conference system according to claim 15, wherein the second electronic device only performs the stereoscopic imaging process for the content of the rectangular box, and does not perform the stereoscopic imaging process for a content outside the rectangular box.

20. The video conference system according to claim 15, wherein the hidden watermark is spread over a plurality of pixels.
